(19) United States
(12) Patent Application Publication
(10) Pub. No.: US 2013/0105642 A1
(43) Pub. Date: May 2, 2013

(54) MAGNETIC APPARATUS FOR SECURING AN OBJECT AND METHOD FOR MAGNETICALLY SECURING AN OBJECT

(71) Applicant: Arielle Marq, Chicago, IL (US)

(72) Inventor: Arielle Marq, Chicago, IL (US)

(73) Assignee: ARIELLE MARQ INCORPORATED, Chicago, IL (US)

(21) Appl. No.: 13/284,298

(22) Filed: Oct. 28, 2011

(51) Int. Cl. F16M 11/04; B23P 11/00; H01F 7/02

(52) U.S. Cl. 248/121; 29/525.03

(57) ABSTRACT

A magnetic securing apparatus is provided and includes a base member, an elongated member extending from the base member, and a magnet attached to the second end of the elongated member. The elongated member has a first end attached to the base member and a second end opposite to the first end. A poster or other article can be secured between the first magnet, and a second magnet that is attached to the first magnet.

### BACKGROUND

There is a desire to display artwork, pictures, and paintings in a variety of interesting and/or aesthetic ways. Traditionally, pictures and paintings have been mounted in a picture frame and hung directly on a wall by means of a wire attached to the frame. The frame is mounted to the wall by hanging the wire on a screw or nail attached to the wall. Additional pieces of hardware may also be attached to the frame, such as sawtooth or triangle hangers, when hanging the frame directly to the nail in the wall. In a wire hanging application, two or more D-rings are permanently attached to the back side of the frame, and a wire is strung between the two D-rings. The front side of the artwork can be illuminated to highlight certain features thereon, or to facilitate easier viewing by an observer. However, there may be occasions where it is desirable to either view or illuminate not only the front side of a piece of hanging art, but also the backside. In this case, it is necessary to position the piece of artwork a certain distance away from a wall. In order to accomplish this, the object could be suspended from a ceiling with wires or cables. However, this can be problematic in that it is expensive and difficult to mount the cables to the ceiling. Moreover, the piece of art may sway back and forth, and the cables may be unsightly to a viewer. In addition, it may be difficult and time consuming to mount and unmount a piece of artwork from the associated support structures. Also, a frame or other supporting structure is usually required to hold the poster, and unsightly mounting hardware such as the sawtooth hangers or D-rings are required to be mounted to such a frame. Finally, common framing methods are expensive and time consuming when attaching the work to a frame.

Therefore, there is a need to overcome the disadvantages described above or otherwise lessen the effects of such disadvantages.

### SUMMARY

In one embodiment, a magnetic securing apparatus includes a base member, an elongated member extending from the base member, the elongated member having a first end attached to the base member and a second end opposite to the first end, and a magnet attached to the second end of the elongated member. In an embodiment, the base member is a shape selected from a group including circular, ovular, triangular, rectangular, square, hexagonal and polygonal. In an embodiment, the base member and the elongated member are at least substantially transparent. In an embodiment, the base member includes a plurality of holes extending therethrough. In an embodiment, the elongated member has a length that is greater than any of the dimensions of the base member. In an embodiment, the elongated member extends at least substantially perpendicular to a main surface of the base member. In an embodiment, the elongated member extends at an angle relative to a main surface of the base member. In an embodiment, the second end of the elongated member includes a recess, and the magnet is positioned in the recess. In an embodiment, the elongated member is cylindrical.

In another embodiment, a method of magnetically securing an object is provided. The method includes attaching at least one magnetic securing apparatus to a surface of a mounting structure, the magnetic securing apparatus including a base member, an elongated member extending from the base member, the elongated member having a first end attached to the base member and a second end opposite to the first end, and a magnet attached to the second end of the elongated member, and securing a portion of the object to the second end of the elongated member by positioning the object between the first magnet and a second magnet. In an embodiment, the elongated member extends at least substantially horizontally from a main surface of the base member. In an embodiment, the elongated member extends at an angle relative to a main surface of the base member. In an embodiment, the object is selected from a group including a poster, a painting, at least one piece of paper, a canvas, a tarp, and a sheet. In an embodiment, the base member and the elongated member are at least substantially transparent. In an embodiment, the base member includes a plurality of holes extending therethrough. In an embodiment, the elongated member has a length that is greater than any of the dimensions of the base member. In an embodiment, the elongated member extends at least substantially perpendicular to a main surface of the base member. In an embodiment, the elongated member extends at an angle relative to a main surface of the base member. In an embodiment, the second end of the elongated member includes a recess, and the magnet is positioned in the recess. In an embodiment, the elongated member is cylindrical.

Additional features and advantages are described herein, and will be apparent from the following Detailed Description and the figures.

### BRIEF DESCRIPTION OF THE FIGURES

FIG. 1A illustrates an exploded front perspective view of a magnetic securing apparatus according to a first embodiment.

FIG. 1B illustrates an exploded front perspective view of a magnetic securing apparatus according to a variation of the first embodiment shown in FIG. 1A.

FIG. 2 illustrates a front perspective view of the magnetic securing apparatus according to the first embodiment shown in FIG. 1A.

FIG. 3 illustrates a front side view of the magnetic securing apparatus according to the first embodiment shown in FIG. 1A, wherein the back side view is a mirror image of this view.

FIG. 4 illustrates a top side view of the magnetic securing apparatus according to the first embodiment shown in FIG. 1A.

FIG. 5 illustrates a bottom side view of the magnetic securing apparatus according to the first embodiment shown in FIG. 1A.

FIG. 6 illustrates a perspective view of a plurality of the magnetic securing apparatuses according to the first embodiment shown in FIG. 1A, showing the magnetic securing apparatuses being secured to a wall and securing a planar object.

FIG. 7 illustrates a front view of a plurality of the magnetic securing apparatuses according to the first embodiment, showing the magnetic securing apparatuses being secured to the wall, and securing the object as shown in FIG. 6.

FIG. 8 illustrates a side view of a second embodiment, illustrating a plurality of magnetic securing apparatuses having a first length, and a plurality of magnetic securing apparatuses having a second shorter length, the ends of the magnetic securing apparatuses having a slanted surface.

FIG. 9 illustrates a perspective view of the second embodiment shown in FIG. 8, illustrating the plurality of magnetic securing apparatuses having a first length and the plurality of magnetic securing apparatuses having a second shorter length, the ends of the magnetic securing apparatuses each having a slanted surface.

FIG. 10 illustrates an enlarged front perspective view of one of the magnetic securing apparatuses shown in FIGS. 8 and 9, and showing the detail of the slanted surface of the end of the extending member of the magnetic securing apparatus.

FIG. 11 illustrates a side view of a third embodiment, including a plurality of magnetic securing apparatuses having a first length and a plurality of magnetic securing apparatuses having a second shorter length, each of the magnetic securing apparatuses including an extending member extending from a base member thereof at a downward angle.

FIG. 12 illustrates a perspective view of the third embodiment shown in FIG. 11, including the plurality of magnetic securing apparatuses having a first length and the plurality of magnetic securing apparatuses having a second shorter length, each of the magnetic securing apparatuses including the extending member extending from a base member thereof at a downward angle.

FIG. 13 illustrates an enlarged front perspective view of one of the magnetic securing apparatuses shown in FIGS. 11 and 12, and showing the detail of the extending member extending from a base member thereof at a downward angle.

FIG. 14 illustrates a front perspective view of a fourth embodiment, showing a magnetic securing apparatus including a magnet housing attached to an end of the cylindrical extending member, the magnetic housing being pivotable with respect to the remainder of the magnetic securing apparatus.

FIG. 15 illustrates a side perspective view of a fifth embodiment, showing a magnetic securing apparatus having a base member including a plurality of magnets for attaching the base member to a wall and to an extending member.

FIG. 16 illustrates a side perspective view of a sixth embodiment, showing a magnetic securing apparatus having a base member including a plurality of magnets for attaching the base member to a wall and to an extending member.

FIG. 17 illustrates a side perspective view of a seventh embodiment, showing a magnetic securing apparatus having a hollow extending member, and that does not include a separate base member.

### DETAILED DESCRIPTION

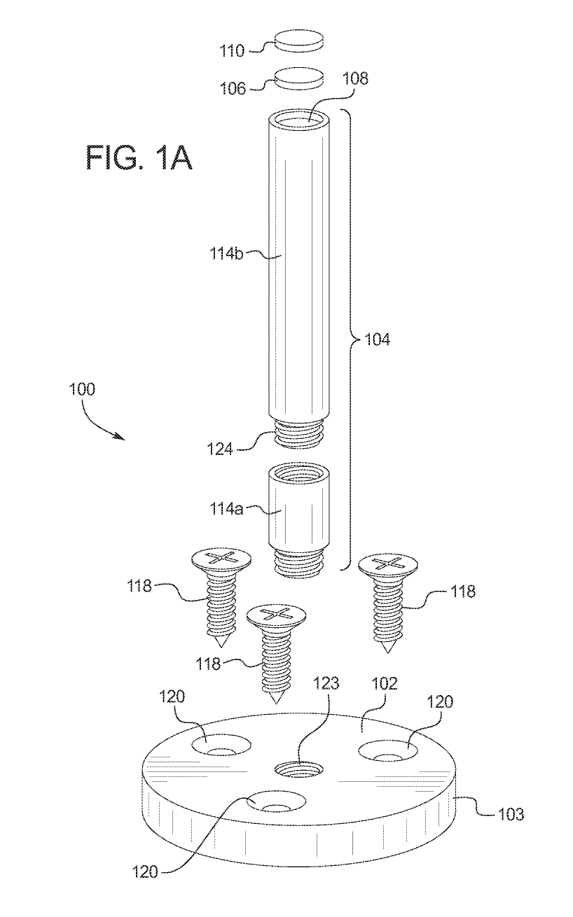

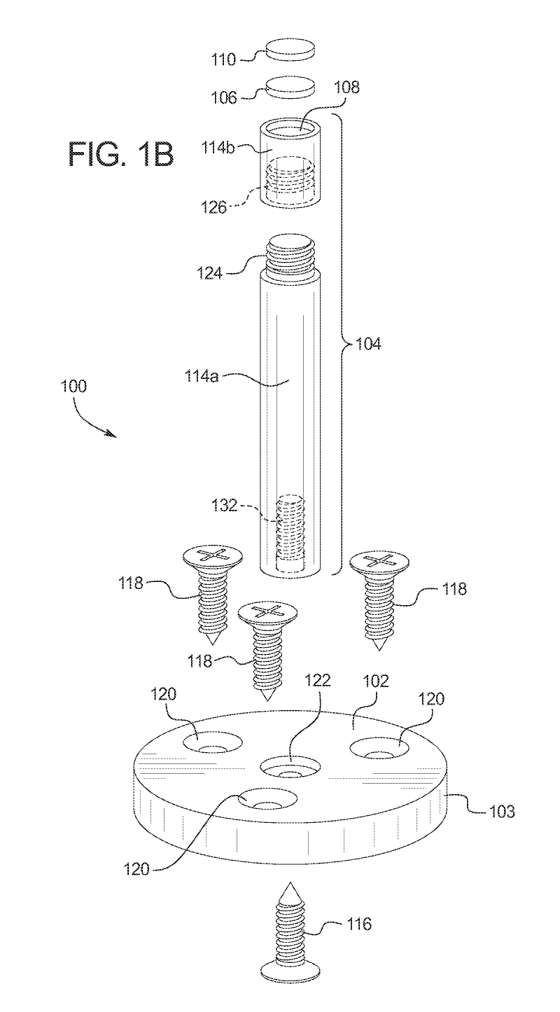

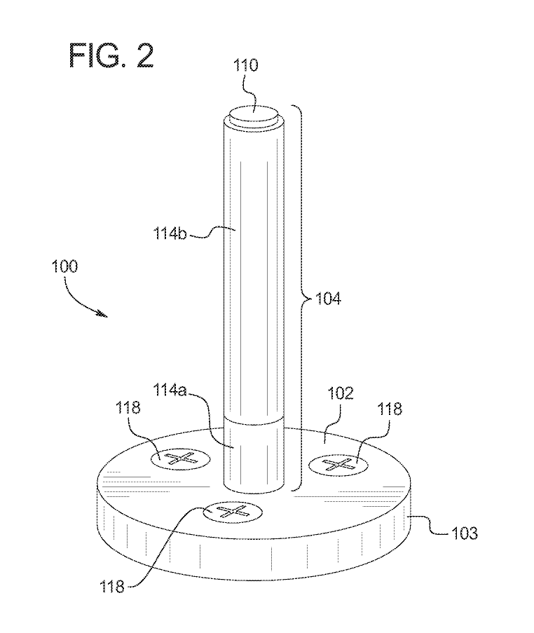

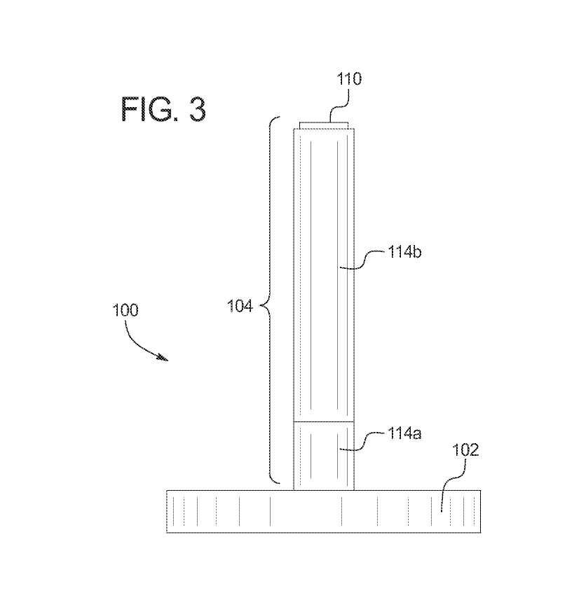

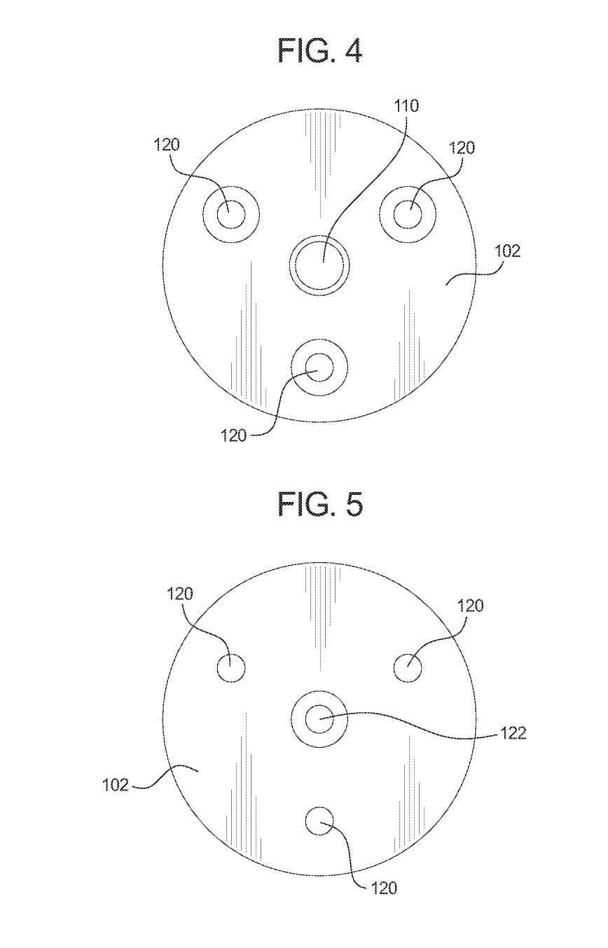

Referring now to the drawings, FIGS. 1A, 1B and 2-6 illustrate embodiments of a magnetic apparatus for securing an object. As shown in either of FIG. 1A or 1B, the magnetic apparatus 100 includes a base member 102, and an elongated member 104 extending from the base member 102. A first end of the elongated member 104 is attached to the base member 102. The length, width, thickness, diameter and any other dimensions of the elongated member and the base member may be varied to suit a particular application, and this applies for each of the embodiments described below. The magnetic apparatus 100 also includes a first magnet 106 attached to a second end of the elongated member 104. A second magnet 110 is removably attached to the first magnet 106, and at least a portion of an object can be secured between the first magnet 106 and the second magnet 110. The diameters of the magnets vary from about ⅛″ to 2″ in thickness, and the thicknesses of the magnets vary from about ¼″ to about ⅝″. However, it should be appreciated that the dimensions and shapes of the magnets can be varied outside the ranges discloses above depending on the application, and this applies for each of the embodiments described herein. It should also be appreciated that as an alternative to a second magnet 110, a ferromagnetic object that is magnetically attracted to the first magnet 106 can also be used. Nonlimiting examples of ferromagnetic materials include iron, nickel, cobalt, certain alloys of rare earth metals, and certain naturally occurring minerals such as lodestone. In examples where one magnet and one ferromagnetic object are used (i.e., rather than two permanent magnets), the relative positions of each may be changed. For example, the ferromagnetic object may be attached directly to the second end of the elongated member 104, or the permanent magnet may be attached directly to the second end of the elongated member 104. This concept applies to any embodiments or examples described herein where a first magnet is attached to a second magnet.

At least a portion of an object may be inserted and held between the two magnets 106 and 110 due to the attractive forces existing there between. The object to be secured can be any suitable object capable of being immobilized by the forces of the opposing magnets. In certain examples, the object is a painting, a poster, a mural, a canvas, a newspaper, a piece of art, a sheet of paper, a sheet of Dura-Lar™ a photograph, an acrylic sheet, a glass sheet, a plastic sheet, or any other suitable object that includes at least a portion thereof that is capable of being held between the first magnet 106 and the second magnet 110. In the case where the object is at least partially transparent, light is allowed to pass through portions of the object and reflect off the mounting surface or wall behind the object. This reflection of light off of the wall enables a certain amount of back lighting of the object. Moreover, the benefits of reduced visual noticeability of the magnetic apparatus 100 discussed herein are appreciated when the object is transparent, because portions of the magnetic apparatus would be observable through and behind the transparent object.

In several of the embodiments illustrated and discussed herein, the object to be secured by the magnets is a planar sheet-like object. However, it should be appreciated that the object may also be only partially planar or non-planar, or may have certain three-dimensional characteristics, provided that at least a portion of the object can be secured by the magnets as discussed above.

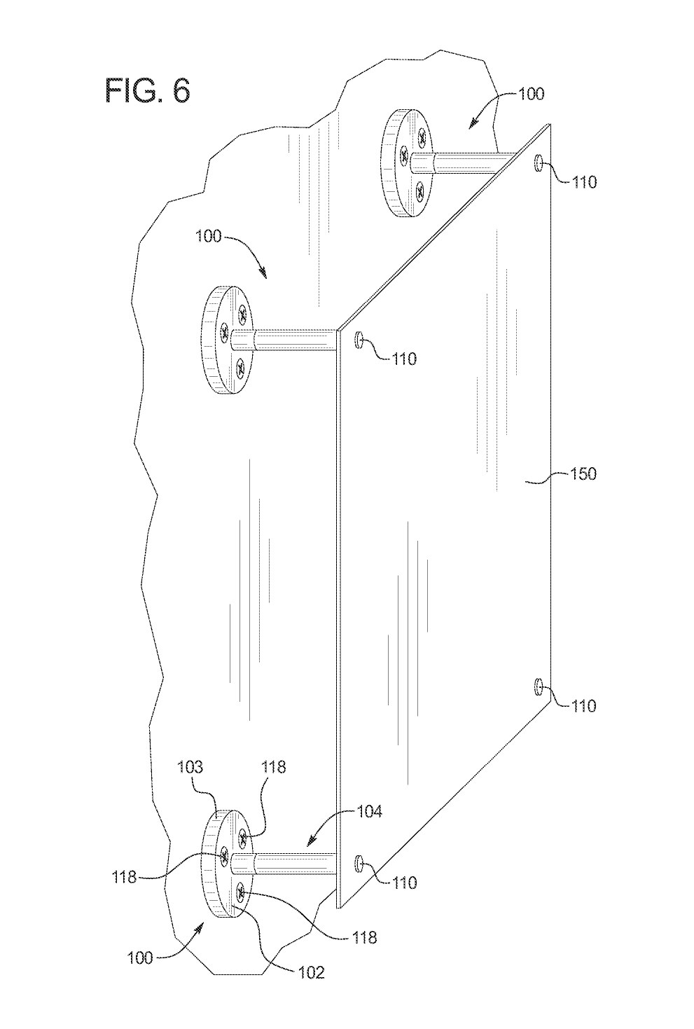

In the embodiment shown in FIGS. 1A, 1B and 2-7, the base member 102 is a substantially circular disk-shaped member. The base member 102 includes a back surface having at least a portion thereof that is at least substantially planar and that is adapted to be mounted to a wall 170 (see, FIG. 6) or other planar surface. In the embodiment shown in FIGS. 1A and 1B, the base member 102 can include one or a plurality of base member holes 120. Screws 118 or other suitable attaching members are inserted through the base member holes 120 in order to attach the base member 102 to a surface. As shown in FIG. 6, the base member 102 is attached to a wall 170. As shown in FIGS. 1A and 1B, the base member holes 120 are countersunk to accept a screw 118 head, and are countersunk to a sufficient depth to enable the screw head to rest flush or slightly below the outer surface of the base member 102. It should be appreciated that in other embodiments, different types of screws, nails or fasteners may be used to secure the base member 102 to the wall 170. For example, the base member 102 can be adhered to the wall with an adhesive, with a removable adhesive wall mount, or a suitable adhesive pull strip product. Moreover, the screws may protrude above the surface of the base member 102. In the embodiment shown in FIG. 1A, the base member includes a female threaded portion 122 that receives the elongated member 104, and in the embodiment shown in FIG. 1B, the base member includes a base member center hole 122 that receives the elongated member 104, as discussed in further detail below.

Although the magnetic apparatuses 100 shown in FIGS. 1A and 1B are shown and described as having a flat disc-shaped base member 102, it should be appreciated that the base member could be any suitable shape such as a square, a rectangle, an ovular shape, or any other suitable polygonal or irregular shape. Although the base member 102 is shown to include several base member holes 120 to accommodate screws or other mounting hardware, it should be appreciated that in other embodiments, there are no base member holes. In these other embodiments, the back side of the base member 102 can be secured to a mounting surface with a suitable adhesive, with hook and loop type fasteners, with clips, nails, or any other suitable mounting method.

Although the base member 102 is shown in FIGS. 1A and 1B to include a female threaded portion 122 (i.e., as shown in FIG. 1A) or a base member center hole 122 (i.e, as shown in FIG. 1B) that accommodates one end of the first member 114a, it should be appreciated that in other embodiments, the base member 102 and the first member 114a of the elongated member 104 are a single integral piece. Moreover, in an embodiment where the first member 114a and the second member 114b are a single piece (i.e., rather than two separate pieces attached together), this single elongated member can be formed integrally with the base member 102.

In certain embodiments, the top circumferential edge 140 of the base member has different profiles. In this embodiment, as shown in FIG. 1, the top circumferential edge 140 of the base member 102 is a straight edge. When light is illuminated on the base member 102, the straight edge has an effect of reducing any reflections of light, thereby reducing an overall shiny appearance of the magnetic apparatus 100 to a viewer. This has an effect of reducing a noticeability of the magnetic apparatus to a viewer, and thereby allowing the viewer to focus more attention on the object that is being secured rather than the magnetic apparatus itself Although the top circumferential edge 140 of the base member 102 is illustrated as having a straight edge, it should be appreciated that this edge may alternatively have a bevel, or it may be curved, or include any other curved or angular surface profile.

In certain embodiments, the surfaces of the base member 102 can have different reflective properties or different surface finish treatments. In one embodiment, an outer circumferential surface 103 of the base member 102 includes a matte surface finish, a roughed-up finish, or a light diffusing finish. In one example, the material of the base member 102 is a transparent material such as glass, plastic or acrylic glass. The top surface of the base member 102 remains polished or smooth relative to the finish of the outer circumferential surface 103. Thus, the outer circumferential surface 103 of the base member 102 has a dull, light-diffusing, or matte finish relative to the top surface of the base member 102. Similar to the effect of having a straight edge for the top circumferential edge 140 of the base member 102 as discussed above, when light is illuminated on the base member 102 having a matte surface for the outer circumferential surface 103, there is an effect of reducing any reflections of light, thereby reducing a shiny overall appearance of the magnetic apparatus 100 to a viewer. This also has an effect of reducing a noticeability of the magnetic apparatus to a viewer, and thereby allowing the viewer to focus more attention on the object that is being secured rather than the magnetic apparatus itself.

In different embodiments, the elongated member 104 can be configured in a number of different ways. In the embodiments shown in FIGS. 1A, 1B, 2 and 3, the elongated member 104 is a cylindrical member. However, it should be appreciated that in other embodiments including the second through seventh embodiments described herein, the elongated member 104 may have a different shaped cross-sectional profile such as square, rectangular, ovular, or any other suitable constant or changing shape along an axial direction of the elongated member 104. The cylindrical member 104 includes a first member 114a and a second member 114b. The first member 114a of the elongated member 104 is attachable to the base member 102 through the female threaded portion 122 (i.e., as shown in FIG. 1A) or the base member center hole 122 (i.e., as shown in FIG. 1B). Certain structural elements common to the embodiments shown in FIGS. 1A and 1B have been described above. However, certain structural differences between these embodiments exist and are described in detail below.

In the embodiment shown in FIG. 1A, the first member 114a is shorter than the second member 114b, and the first member 114a includes a male threaded member 124 that is matable with a female threaded portion 122 formed into the surface of the base member 102. The first member 114a of the elongated member 104 attachable to the base member 102 by screwing the male threaded portion 124 of the first member 114a into the female threaded portion 122 formed into the base member 102. The other end of the first member 114a is a female threaded portion 132 that corresponds to a male threaded portion 126 formed on the bottom of the second member 114b of the extending member 104. In this embodiment, the second member 114b screws onto the first member 114a via the respective female and male threaded portions 132 and 126 of same.

As mentioned above, certain structural elements and methods of connectivity between these structural elements differ between the embodiment shown in FIG. 1A and that shown in FIG. 1B. In contrast to the embodiment of FIG. 1A, in the embodiment shown in FIG. 1B, the first member 114a is longer than the second member and includes a threaded recess 132 at a first end. When the first member 114a of the elongated member 104 is inserted into the base member center hole 122, a screw 116 is inserted through the base member center hole 122 from the bottom side of the base member 102 and up through the threaded recess 132 of the first member 114a in order to secure the first member 114a to the base member 102. The other end of the first member 114a is a male threaded portion 124 that corresponds to a female threaded portion 126 of the second member 114b of the extending member 194. In this embodiment, the second member 114b screws onto the first member 114a via the male and female threaded portions 124 and 126 of same.

For both of the embodiments shown in FIGS. 1A and 1B, the second member 114b includes a cylindrical recessed portion 108 at a distal end. A first magnet 106 is inserted into the recessed portion 108. The first magnet 106 can be attached to the recessed portion with an adhesive, with a press-fit connection, or with any other suitable connecting technique. In this embodiment, the first magnet 106 is permanently mounted in the recessed portion 108 of the second member 114b. However, it should be appreciated that the first magnet 106 may also be removably mounted in the recessed portion 108. As shown in FIGS. 1A and 1B, a second magnet 110 is removably attached to the first magnet 106. In this manner, an object such as a poster can be inserted and held between the two magnets. It should also be appreciated that the elongated member 104 may be a single member (i.e., rather than a combination of first member 114a and second member 114b), or it may include three or more members attached together in any suitable manner described herein and including magnetic attachment.

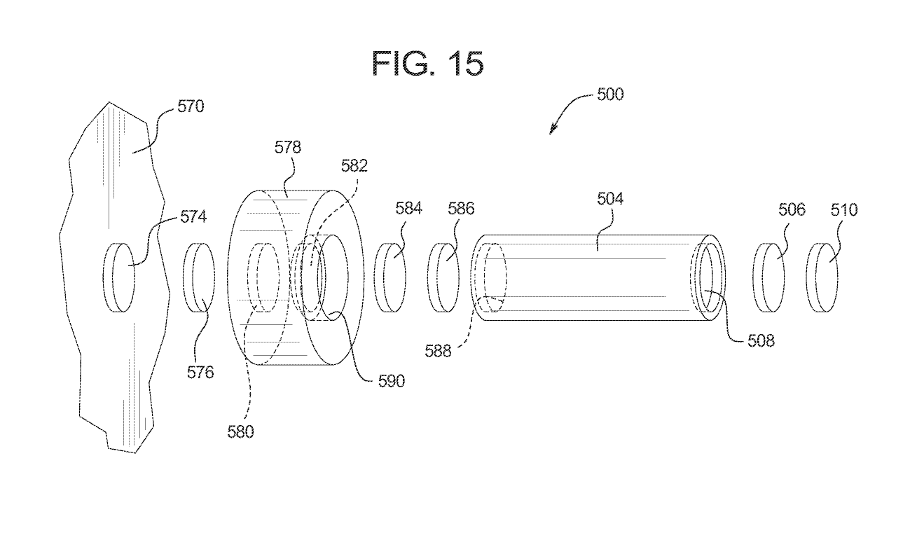

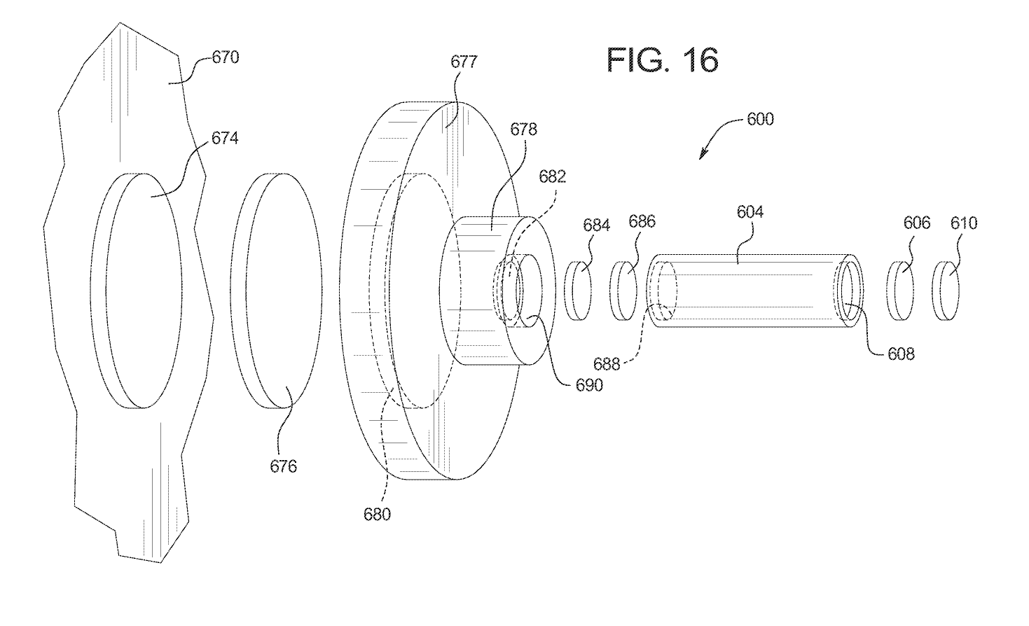

The base member 102 can be attached to the extending member 104 in a number of different ways. Although in the embodiment shown in FIG. 1A the first member 114a of the elongated member 104 is shown to be attached to the base member 102 by screwing the male threaded portion 124 into the female threaded portion 122, and in the embodiment shown in FIG. 1B the first member 114a of the elongated member 104 is shown to be attached to the base member 102 with the screw 116, it should be appreciated that any other suitable method of attaching these two parts may be used. For example, the first member 114a can be attached to the base member 102 with an adhesive, by a press-fit connection, a friction fit connection, or the lower end of the first member 114a and the base member center hole 122 can include male-female threads similar to that discussed herein with regard to the top end of the first member 114a and the bottom end of second member 114b. Moreover, regardless of whether the elongated member 104 is a single piece, or if it includes two or more pieces (e.g., first member 114a and second member 114b), in an embodiment the elongated member 104 may be attached to the base member 102 magnetically. In one embodiment, the base member 102 includes a recessed portion (i.e., rather than the base member center hole 122 shown in FIG. 1B) having a magnet mounted therein, and the elongated member also includes a magnet at one end thereof for attaching the elongated member magnetically to the base member. In this embodiment, a portion of the elongated member is inserted into the recess formed into the based member to increase the stability of the connection between the two magnetically connected objects. Variations of this concept are discussed further with respect to the embodiments shown in FIGS. 15 and 16.

Although in the embodiments shown in FIGS. 1A and 1B, the first magnet 106 is shown as being mounted in a recess 108 of the second member 114b, it should be appreciated that the second member 114b may not include a recess and the magnet 106 may be adhered directly to the flat end surface of the second member 114b of the elongated member 104.

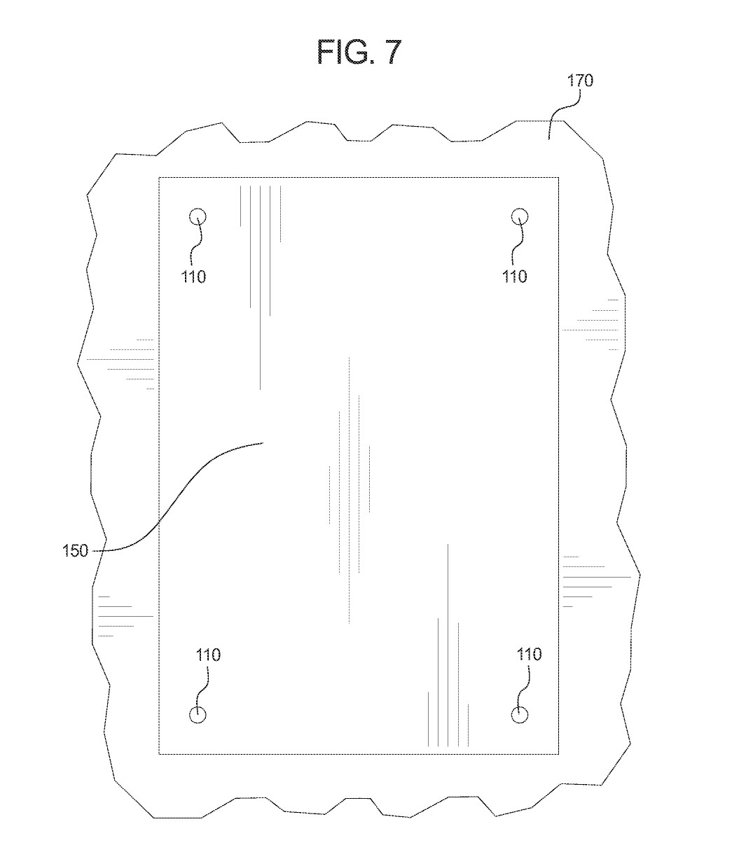

In an embodiment, four or more magnetic apparatuses 100 are mounted to a wall 170. As shown in FIGS. 6 and 7, the magnetic apparatuses 100 are mounted to correspond to the four corners of a rectangular planar sheet-like object 150. Each of the four corners of the object 150 are inserted between first magnets 106 (as shown in FIGS. 1A and 1B) and second magnets 110 of the respective magnetic apparatuses 100. In this manner, the object 150 is held or suspended by the mounting apparatuses 100, and the position of the object 150 is fixed relative to the wall 170. According to this embodiment, by adjusting the length of the first member 114a, the second member 114b (or both of the members), a distance can be set between the object 150 and the mounting surface (e.g., the wall 170). Either or both of the first member 114a and the second member 114b can be unscrewed and replaced with a different member having a different length. Likewise, in embodiments where the elongated member 104 is a single member (i.e., rather than including both the first member 114a and second member 114b as shown in FIGS. 1A and 1B), the single member can be removed and replaced with an elongated member of a different length. In this way, it is relatively easy to adjust the mounting appearance and the distance that the object 150 is positioned away from the wall 170. In certain applications, it may be desirable to have the object 150 close to the wall 170. However, in other applications, it may be more aesthetically pleasing to have the object 150 positioned a far distance from the wall 170 to give the appearance or the illusion that the object 150 is unsupported or floating in space, or to provide reflective backlighting of the object.

In the embodiment shown in FIGS. 1A, 1B and 2-7, the material of the base member 102 and the elongated member 104 is a transparent material such as a poly(methyl methacrylate) (PMMA) acrylic glass, a polycarbonate material, glass, crystal, or any other suitable transparent material. By having the material of the magnetic apparatus 100 be transparent, this enhances the aesthetic appearance of the object 150 that is suspended. Due to the transparent nature of the apparatus, a viewer's focus of attention may be less easily drawn to the supporting structure and instead be focused on the actual object 150 that is being displayed. Moreover, in the case that the object is separated from the wall by a certain distance, the transparent material of the magnetic apparatus 100 gives an illusion that the object 150 is floating or suspended in mid-air. Although one embodiment and certain benefits associated therewith have been described utilizing a transparent material, it should be appreciated that any other suitable colors or materials may be used. For example, in certain applications, it may be desirable to match the color of the magnetic apparatus to the color of the wall or to certain colors in the object that is secured. These variations can be applied to any of the embodiments disclosed herein.

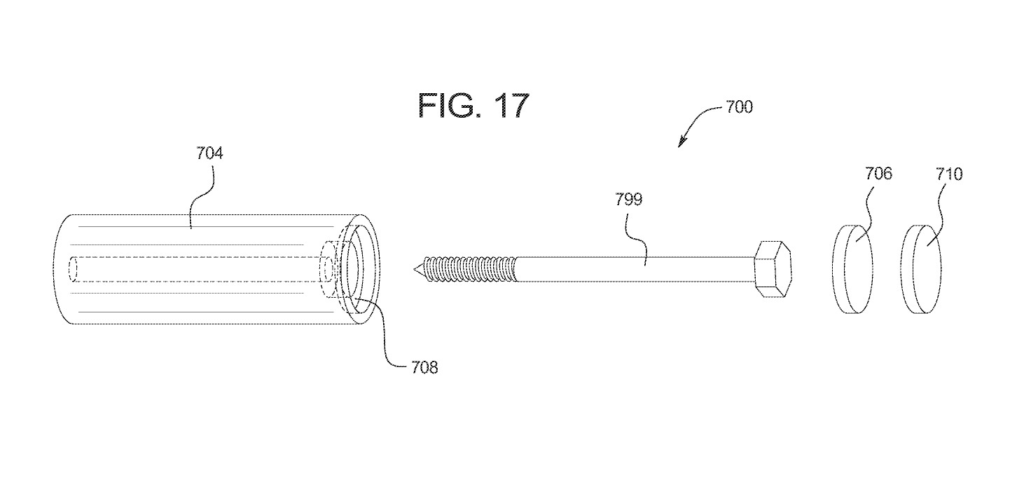

In other embodiments, the appearance of the magnetic apparatus 100 may be changed by inserting one or more different colored objects into the interior of a transparent elongated member 104. In these embodiments, all or at least a portion of the elongated member 104 is hollow along a length direction of the elongated member 104, with the hollow opening to one or both ends of the elongated member 104. FIG. 1B shows an embodiment where a portion of the elongated member includes a first member hollow 132 to accommodate a portion of the mounting screw 116. However, such a hollow can also accommodate a hollow or solid colored insert portion. For example, a hollow colored straw may be inserted within the hollow to give the elongated member a colored appearance. These colored inserts can be easily removed and changed depending on the aesthetic requirements of the object, the display, or the environment in which the object is hung, as discussed in further detail below with respect to the embodiment shown in FIG. 17. These variations can be applied to any of the embodiments disclosed herein.

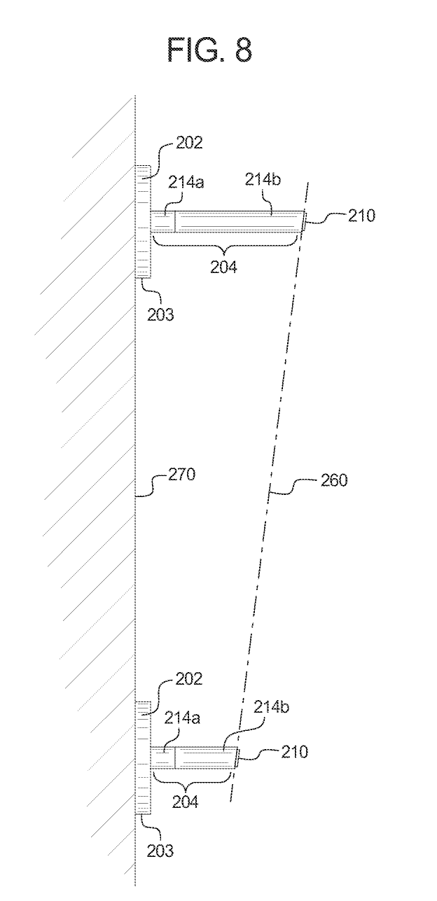

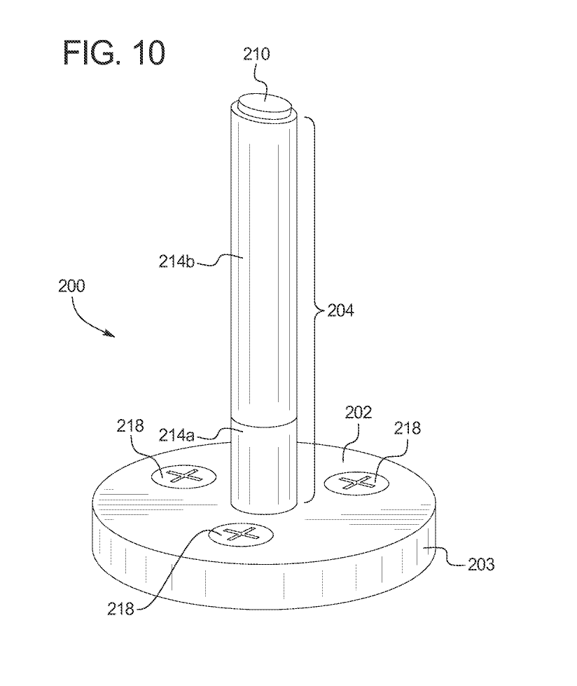

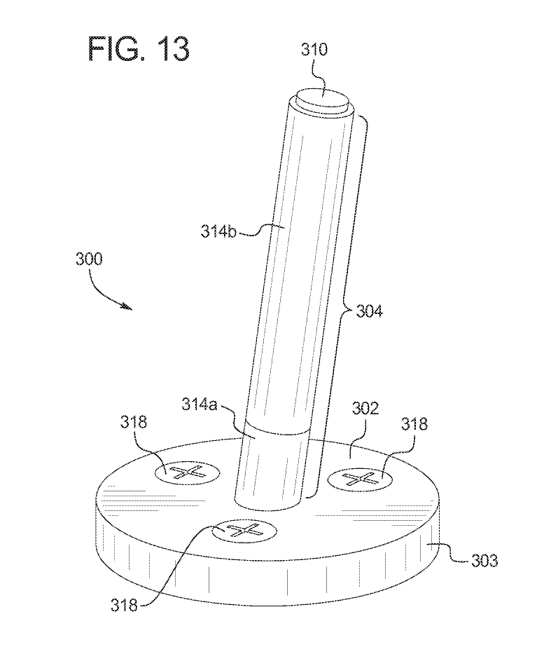

In certain circumstances, it may be desirable to display artwork at an angle relative to the wall on which it is mounted. For example, if a piece of artwork is very large, or if it is mounted high up on an area of a wall where a viewer is required to glance upward to view all or at least a portion of the piece, it may be desirable to tilt the piece downward to enable easier viewing. As discussed above, in traditional frame-mounted picture hanging systems, a picture is mounted in a rectangular frame and a wire is suspended between two or more points on the frame. Depending on the desired viewing angle, the length or positions of the wire can be adjusted, and/or the lengths of the wall fasteners can be adjusted so that the top edge of the picture frame tilts outwardly from the wall. The embodiments shown in FIGS. 8-13 include embodiments of magnetic hanging systems that enable a picture to be suspended at a angle relative to the wall. The embodiments shown in FIGS. 1A, 1B and 2-7 can also enable an object to hung at an angle relative to the wall if different length extending members 104 are used.

In a second embodiment, as shown in FIGS. 8-10, a magnetic hanging system 200 includes a plurality of first magnetic apparatuses 201 and a plurality of second magnetic apparatuses 205 that enable the object to be mounted at an angle with respect to the wall 270. The first magnetic apparatuses 201 have a first length, and the second magnetic apparatuses 205 have a second length that is shorter than the first length. In this embodiment, similar to the embodiments shown in FIGS. 1A and 1B, a planar sheet-like object is held between the flat surfaces of two opposing magnets. In the embodiment shown in FIG. 1A, the elongated member 104 extends perpendicularly with respect to the wall 170 (see, FIG. 6) and with respect to a main surface of the base member 102, and the magnet 108 is mounted in a recess 108 formed into the end of the elongated member 104. As shown in FIG. 1, the surface of the magnet 106 is parallel with respect to the surface of the wall and with respect to the surface of the base member 102, and for each of the four magnetic apparatuses 100 the surfaces of each of the magnets 106 are each approximately the same distance from the wall. Thus, when each of the four corners of the object 150 (see, FIG. 6) are secured between the magnets 106 and 110, the surface of the object 150 is at least substantially co-parallel with the surfaces of each of the magnets 106 and 110 and with the surface of the wall 170. Accordingly, the object 150 is able to be mounted in a planar state. However, if one magnetic apparatus 100 is longer than the other, the surfaces of each of the magnets will be offset from one another and lie in different planes.

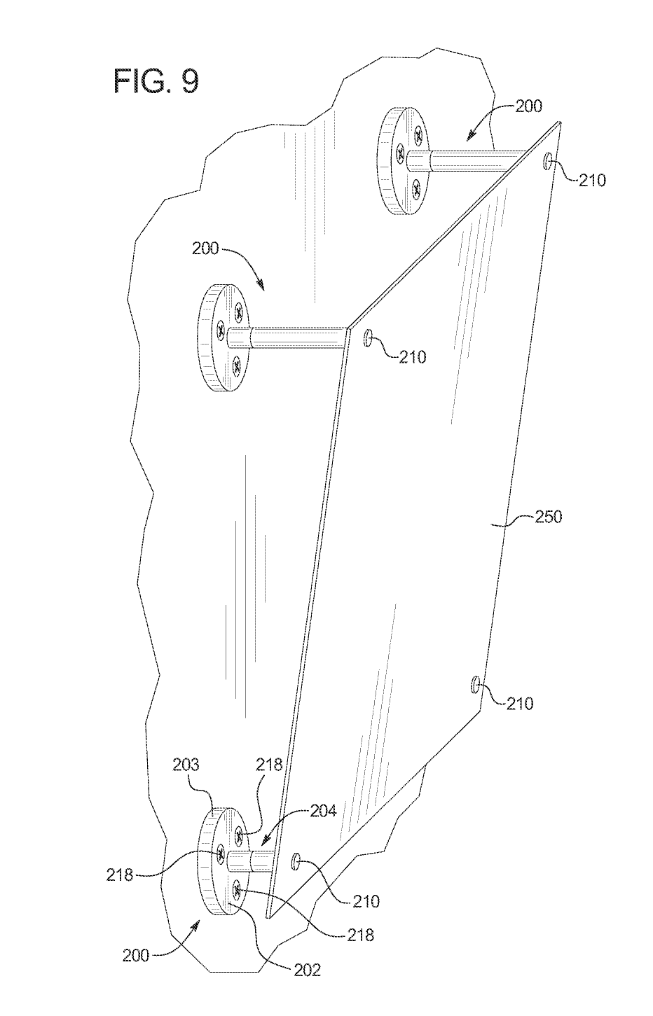

However, in the second embodiment shown in FIGS. 8-10, because the plurality of first magnetic apparatuses 201 extend further from the wall 270 than the plurality of second magnetic apparatuses 205, and the angles of the outer ends of the elongated members 204 are set at an angle, the surfaces of the disc-shaped magnets are also tilted at an angle. In this embodiment, the elongated members 204 extend perpendicularly with respect to the main surface of the base member 202 and the wall 270. Accordingly, there is a common plane 260 in space that at least substantially coincides with the planes defined by the ends of elongated members 204 of the first and second magnetic apparatuses 201 and 205. Moreover, the common plane 260 is set at an angle relative to the angle of the wall 270, and also at least substantially corresponds to the angle of the plane of the object 250 that is hung (see, FIG. 9).

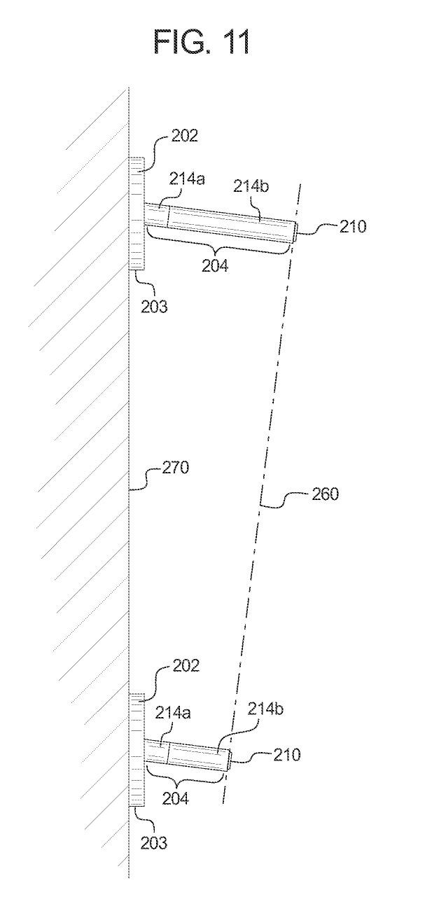

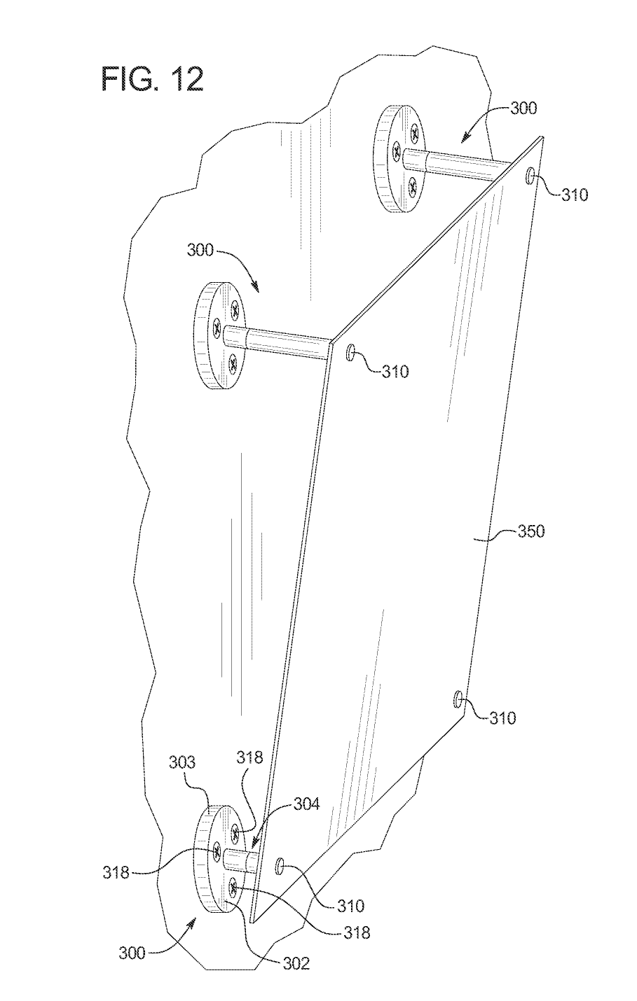

Moreover, in a third embodiment as shown in FIGS. 11-13, the elongated members 304 extend at an angle with respect to the main surface of the base member 302 and the wall 370. The magnets 306 are attached to the second member 314b of the elongated member 302 such that the planes formed by the main surfaces of the magnets 306 are perpendicular with an extending direction of the elongated member 304. Accordingly, similar to the embodiment shown in FIGS. 8-10, there is a common plane 360 in space that at least substantially coincides with the planes defined by the ends of elongated members 304 of the first and second magnetic apparatuses 301 and 305. Moreover, the common plane 360 is set at an angle relative to the angle of the wall 370, and also at least substantially corresponds to the angle of the plane of the object 350 that is hung (see, FIG. 12). Accordingly, the main difference between the embodiment shown in FIGS. 8-10 and that shown in FIGS. 11-13 is that in FIGS. 8-10 the ends of the elongated members 304 are formed at an angle, and in FIGS. 11-13 the elongated members 304 themselves are extended from the base members 302 at an angle.

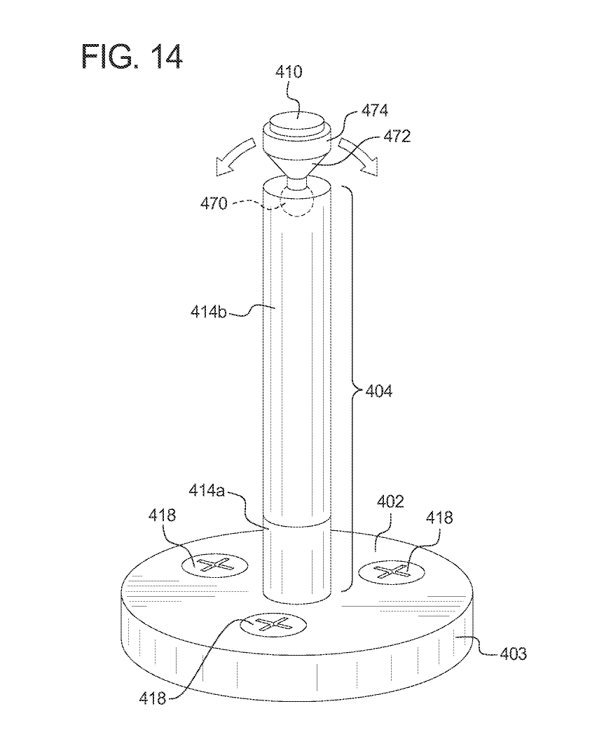

In a fourth embodiment, as shown in FIG. 14, the magnets are pivotally connected to the elongated member 404. In this embodiment, a magnetic apparatus 400 includes a base member 402, and an elongated member 404 extending from the base member 402. A first end of the elongated member 404 is attached to the base member 402. The magnetic apparatus 400 also includes a first magnet (not shown but analogous to magnet 106 shown in FIG. 1A) is attached to a second end of the elongated member 404. A second magnet 410 is removably attached to the first magnet and at least a portion of an object can be secured between the first magnet and the second magnet 410. In this embodiment, a magnet housing 474 is pivotally attached to the second member 414b of the elongated member 404. In an embodiment, a sloping surface 472 may be applied to a lower portion of the magnet housing 474 to enable the magnet housing to freely pivot without interfering with the top portions of the second member 414b of the extending member 404. In this embodiment, the magnet housing 474 includes a recess (not shown but analogous to recess 108 shown in FIG. 1A). The first magnet is mounted in the recess, and the second magnet 410 is attached to the first magnet. In this embodiment, the planes of the first magnets (and the main end surface of the magnet housing 474) can be freely rotated in order to adjust to any changing lengths of the extending members. In this regard, there may be additional flexibility with respect to changing the planar angles of the magnets relative to the embodiments discussed above with regard to FIGS. 8-13.

In a fifth embodiment shown in FIG. 15, the respective components of the magnetic apparatus are mounted to one another magnetically, and also mounted to the wall magnetically. In this embodiment, a magnetic apparatus 500 includes a receiving base member 578, and an elongated member 504 extending from the receiving base member 578. A wall magnet 574 is mounted to the wall 570. This magnet can be mounted to the wall by an adhesive, a hook-and-loop fastener or by any other suitable fastening technique. In the bottom portion of the receiving base member 578 a recess 580 is formed, and in this recess 580 a magnet 576 is inserted therein. The receiving base member 578 can then be attached to the wall by connecting wall magnet 574 to the magnet 576 set in the recess 580 of the receiving base member 578. In an embodiment, the recess 580 is deep enough to accommodate the thickness of both the wall magnet 574 and the magnet 576. In this manner, the receiving base member 578 can be mounted flush with the wall 570. In the front side of the receiving base member 578, another recess 582 is formed that accommodates both magnet 584 and the bottom portion of extending member 504. In this regard, the recess 582 has a portion with a larger diameter 590 than the diameter of the magnet 584 in order to be able to receive the larger end portion of the extending member 504. In this embodiment, the extending portion includes a first recess 588 to receive magnet 586, and a second recess 508 to receive magnet 506. The extending member 504 is removably connected with the receiving base member 578 by inserting the end of extending member 504 into the larger diameter portion 590 of recess 582 and connecting the magnets 584 and 586 together. A second magnet 510 is removably attached to the first magnet 506 and at least a portion of an object can be secured between the first magnet and 506 the second magnet 510. This embodiment has a feature that component pieces of the magnetic apparatus 500 can be exchanged and removed easily without requiring any tools.

In a fifth embodiment shown in FIG. 16, the respective components of the magnetic apparatus are mounted to one another magnetically, and also mounted to the wall magnetically. The embodiment of FIG. 16 is capable of securing objects of larger mass relative to the embodiment shown in FIG. 15, because of the larger size and diameter of the magnet 676 discussed below. In this embodiment, a magnetic apparatus 600 includes a receiving base member 678, and an elongated member 604 extending from the receiving base member 678. The receiving base member 678 includes a portion having a larger diameter portion 677. The larger diameter portion 677 may be integrally formed as a part of the receiving base member 678, or may be a separate disc-shaped based member component that is attached to the receiving base member 678. A large diameter wall magnet 674 is mounted to the wall 670. This magnet 674 can be mounted to the wall by an adhesive, a hook-and-loop fastener or by any other suitable fastening technique. In the bottom portion of the larger diameter portion 677 of the receiving base member 678 a recess 680 is formed, and in this recess 680 a magnet 676 is inserted therein. The receiving base member 678 can then be attached to the wall by connecting wall magnet 674 to the magnet 676 set in the recess 680 of the larger diameter portion 677. In an embodiment, the recess 680 is deep enough to accommodate the thickness of both the wall magnet 674 and the magnet 676. In this manner, the receiving base member 678 can be mounted flush with the wall 670. In the front side of the receiving base member 678, another recess 682 is formed that accommodates both magnet 684 and the bottom portion of extending member 604. In this regard, the recess 682 has a portion with a larger diameter 690 than the diameter of the magnet 684 in order to be able to receive the larger end portion of the extending member 604. In this embodiment, the extending portion includes a first recess 688 to receive magnet 686, and a second recess 608 to receive magnet 606. The extending member 604 is removably connected with the receiving base member 678 by inserting the end of extending member 604 into the larger diameter portion 690 of recess 682 and connecting the magnets 684 and 686 together. A second magnet 610 is removably attached to the first magnet 606 and at least a portion of an object can be secured between the first magnet and 606 the second magnet 610. Similar to the embodiment discussed above with regard to FIG. 15, this embodiment has a feature that component pieces of the magnetic apparatus 600 can be exchanged and removed easily without requiring any tools.

In a seventh embodiment shown in FIG. 17, a magnetic apparatus 702 includes a hollow extending member 704. A long screw, nail or other fastening device can be inserted entirely through the hollow extending member 704 and into the wall 770. In one embodiment, the end of the elongated member 704 that is away from the wall 770 also includes a recess having a larger diameter than the diameter of the hollow. In this regard, when a screw or other fastening member is inserted through the hollow of the extending member 704, the head of the screw is stopped on the shoulder defined by the transition from the narrower diameter hollow and the larger diameter recess. In this embodiment, the extending portion 704 includes first recess 708 to receive a magnet 706. A second magnet 710 is removably attached to the first magnet 706 and at least a portion of an object can be secured between the first magnet 706 and the second magnet 710. As discussed above, certain embodiments include an extending member having a hollow interior. In this hollow interior, various colored objects may be inserted to change the overall appearance of the magnetic apparatus 702. In this embodiment, a metal screw may be considered unsightly in certain applications. Therefore, to disguise the presence of the screw, a hollow colored insert (e.g., a colored plastic straw) can be inserted into the hollow and around the screw. In addition, the hollow interior of the extending member 704 can be painted any suitable color such as white.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A magnetic securing apparatus comprising:
a base member;
an elongated member extending from the base member, the elongated member having a first end attached to the base member and a second end opposite to the first end; and
a magnet attached to the second end of the elongated member.

2. A magnetic securing apparatus according to claim 1, wherein the base member is a shape selected from the group consisting of: circular, ovular, triangular, rectangular, square, and polygonal.

3. A magnetic securing apparatus according to claim 1, wherein the base member and the elongated member are at least substantially transparent.

4. A magnetic securing apparatus according to claim 1, wherein the base member includes a plurality of holes extending therethrough.

5. A magnetic securing apparatus according to claim 1, wherein the elongated member has a length that is greater than any of the dimensions of the base member.

6. A magnetic securing apparatus according to claim 1, wherein the elongated member extends at least substantially perpendicular to a main surface of the base member.

7. A magnetic securing apparatus according to claim 1, wherein the elongated member extends at an angle relative to a main surface of the base member.

8. A magnetic securing apparatus according to claim 1, wherein the second end of the elongated member includes a recess, and the magnet is positioned in the recess.

9. A magnetic securing apparatus according to claim 1, wherein the elongated member is cylindrical.

10. A method of magnetically securing an object, the method comprising:
attaching at least one magnetic securing apparatus to a surface of a mounting structure, the magnetic securing apparatus including
a base member,
an elongated member extending from the base member, the elongated member having a first end attached to the base member and a second end opposite to the first end, and
a magnet attached to the second end of the elongated member; and
securing a portion of the object to the second end of the elongated member by positioning the object between the first magnet and a second magnet.

11. The method of magnetically securing an object according to claim 10, wherein the elongated member extends at least substantially horizontally from a main surface of the base member.

12. The method of magnetically securing an object according to claim 10, wherein the elongated member extends at an angle relative to a main surface of the base member.

13. The method of magnetically securing an object according to claim 10, wherein the object is selected from the group consisting of: a poster, a painting, at least one piece of paper, a canvas, a tarp, and a sheet.

14. The method of magnetically securing an object according to claim 10, wherein the base member and the elongated member are at least substantially transparent.
